(19) United States
(12) Patent Application Publication
(10) Pub. No.: US 2014/0104580 A1
(43) Pub. Date: Apr. 17, 2014

(54) PROJECTION DEVICE

(71) Applicants: Chih-Hsien Tsai, Hsinchu (TW); Chao-Shun Chen, Hsinchu (TW); Matthew Glen Hine, Hsinchu (TW)

(72) Inventors: Chih-Hsien Tsai, Hsinchu (TW); Chao-Shun Chen, Hsinchu (TW); Matthew Glen Hine, Hsinchu (TW)

(73) Assignee: YOUNG OPTICS INC., Hsinchu (TW)

(21) Appl. No.: 13/872,169

(22) Filed: Apr. 29, 2013

(30) Foreign Application Priority Data
Oct. 12, 2012 (CN) 201210386980.4

(51) Int. Cl. G03B 21/28; G02B 27/14

(52) U.S. Cl. CPC G03B 21/28; G02B 27/14
USPC 353/30; 359/629; 359/638

(57) ABSTRACT

The disclosure provides a projection device, including an image source, a light-splitting module, and an imaging lens. The image source provides an image beam. The image beam includes a plurality of sub-image beams respectively emitted from a plurality of image areas of the image sources. The light-splitting module has at least one total reflection plane totally reflecting at least one sub-image beam of the sub-image beams and allowing at least another sub-image beam of the sub-image beams to transmit therethrough. The imaging lens includes a rear refractive-element group and a front refractive-element group. The rear and front refractive-element groups are configured on a transmission path of the image beam, and the light-splitting module is configured between the rear and front refractive-element groups.

### CROSS-REFERENCE TO RELATED APPLICATION

This application claims the priority benefit of China application serial no. 201210386980.4, filed on Oct. 12, 2012. The entirety of the above-mentioned patent application is hereby incorporated by reference herein and made a part of this specification.

### TECHNICAL FIELD

The disclosure relates to a display device, and particularly relates to a projection device.

### BACKGROUND

With the advance of modern technology, a variety of projection devices are widely applied in various occasions, such as those for presentations, talks, theaters, teaching activities, interactive learning activities, and home theaters. Generally speaking, in correspondence to larger projected images, the conventional technology utilizes an additional complex lens set for light-splitting and enlarging the image of the image source. Another known technology also utilizes a projection system combining images projected by a plurality of projection devices. However, the projection device or projection system consequently has a greater size. In addition, the complex lens set has a higher cost and is difficult to assemble, rendering a higher cost of this kind of projection devices and making it difficult to lower the selling price for further popularization.

In addition, if the projection device is utilized to create a video-wall-like effect, an aspect ratio of the video wall may be higher than the aspect ratios of light valves of the conventional projection devices. Even if a plurality of projection devices are assembled to generate an image meeting the aspect ratio of the video wall, the system is still over-sized.

US publication no. 20010022651 discloses an adjoined display device, including a transmission-type screen, projectors, and light-shading device, wherein the light-shading device has a shading part for shading a portion of light quantity where images are overlapped. U.S. Pat. No. 8,167,436 discloses a display system, including a projector. An image beam projected by the projector may be divided into three displaying images that form a laterally-arranged complete image.

### SUMMARY

The disclosure provides a projection device splitting beams from different image areas of an image source for respective projections.

The disclosure provides a projection device, including an image source, a light-splitting module, and an imaging lens. The image source provides an image beam and includes a plurality of different image areas. The image beam includes a plurality of sub-image beams respectively emitted from the image areas. An imaging lens includes a light-splitting module, a rear refractive-element group, and a front refractive-element group. The light-splitting module has at least one total reflection plane totally reflecting at least one sub-image beam of the sub-image beams and allowing at least another sub-image beam of the sub-image beams to transmit therethrough. The imaging lens includes a rear refractive-element group and a front refractive-element group. The rear refractive-element group is configured on a transmission path of the image beam and located between the image source and the light-splitting module. The front refractive-element group is configured on transmission paths of the sub-image beams, wherein the rear refractive-element group and the front refractive-element group define an aperture, and the aperture is located between the rear refractive-element group and the front refractive-element group, and the light-splitting module is configured between the rear refractive-element group and the front refractive-element group.

In an embodiment of the disclosure, the at least one total reflection plane has a plurality of total reflection planes, and each of the sub-image beams emitted to the corresponding total reflection plane with an incident angle larger than or equal to a critical angle of the corresponding total reflection plane is totally reflected by the corresponding total reflection plane, while each of the sub-image beams emitted to the corresponding total reflection plane with an incident angle smaller than the critical angle transmits through the corresponding total reflection plane.

In an embodiment of the disclosure, at least a portion of the total reflection planes intersect each other.

In an embodiment of the disclosure, at least a portion of the total reflection planes are sequentially arranged on a transmission path of at least one sub-image beam of the sub-image beams.

In an embodiment of the disclosure, the front refractive-element group includes a plurality of sub-lens groups respectively configured on the transmission paths of the sub-image beams, a central sub-lens group of the sub-lens groups is configured on a transmission path of the sub-image beams transmitting through the total reflection planes, the image areas are arranged in an arrangement direction, and a chief ray of one of the rest of the sub-image beams emitted from a central point of the corresponding image area is located between a reference plane and the corresponding sub-lens group when the chief ray passes the corresponding sub-lens group, wherein the reference plane includes an optical axis of the central sub-lens group and substantially vertical to the arrangement direction.

In an embodiment of the disclosure, the light-splitting module further includes at least one reflection surface configured on a transmission path of at least one sub-image beam of the sub-image beams from the total reflection planes, so as to reflect the at least one sub-image beam to the front refractive-element group.

In an embodiment of the disclosure, the front refractive-element group includes a plurality of lenses respectively configured on light-transmission paths of the sub-image beams, and the light-splitting module includes a plurality of prisms, wherein a gap is formed among the prisms to form the at least one total reflection plane.

In an embodiment of the disclosure, the lenses are laminated to or formed integrally with a portion or a complete portion of the prisms.

In an embodiment of the disclosure, the front refractive-element group includes a lens configured on the light-transmission paths of the sub-image beams, and the light-splitting module includes a plurality of prisms, wherein a gap is formed among the prisms to form the at least one total reflection plane.

In an embodiment of the disclosure, the lens is laminated to or formed integrally with a portion or a complete portion of the prisms.

In an embodiment of the disclosure, the image areas are arranged along a first direction, a plurality of images formed by the sub-image beams and being respectively projected onto an imaging plane by the front-refractive element group are arranged along a second direction, and the first direction is substantially vertical to the second direction.

In an embodiment of the disclosure, the front refractive-element group enables the sub-image beams respectively project onto a plurality imaging planes, wherein at least a portion of the imaging planes are not on the same plane.

In an embodiment of the disclosure, at least a portion of the sub-image beams has a different projection distance.

In an embodiment of the disclosure, at least a portion of the imaging planes are not parallel to each other.

In an embodiment of the disclosure, at least a portion of the sub-image beams is projected with different projection ratios from the others.

The disclosure provides an imaging lens adapted for imaging an image beam, including a light-splitting module, a rear refractive-element group, and a front refractive-element group. The light-splitting module has at least one total reflection plane totally reflecting at least one sub-image beam of a plurality of sub-image beams in the image beam and allowing at least another sub-image beam of the sub-image beams to transmit therethrough; The rear refractive-element group is configured on a transmission path of the image beam and located between the image source and the light-splitting module. The front refractive-element group is configured on transmission paths of the sub-image beams. An aperture is defined between the rear refractive-element group and the front refractive element group, and the light-splitting module is configured between the rear refractive-element group and the front refractive-element group.

The embodiments of the disclosure have at least one of the following advantages or effects. The embodiments of the disclosure splits beams from different image areas of the image sources with the light-splitting module by making use of different incident angles to the light splitting module, thereby enabling projecting different images. In this way, the projection device in the embodiments of the disclosure is allowed to use a light valve to project a plurality of different images, thereby reducing a number of optical elements on the transmission path of the image beam and allowing the size of the projection device to be reduced.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1A is a schematic view illustrating a projection device according to an embodiment of the disclosure.

FIG. 1B is a variation of the projection device according to the embodiment illustrated in FIG. 1A.

FIG. 2 is a schematic perspective view illustrating a projection device according to another embodiment of the disclosure.

FIG. 3 is a schematic view illustrating a projection device according to another embodiment of the disclosure.

FIG. 4 is a schematic view illustrating a projection device according to still another embodiment of the disclosure.

FIG. 5 is a schematic view illustrating a projection device according to another embodiment of the disclosure.

FIG. 6 is a schematic view illustrating a projection device according to still another embodiment of the disclosure.

FIG. 7 is a schematic view illustrating a projection device according to yet another embodiment of the disclosure.

### DETAILED DESCRIPTION OF DISCLOSED EMBODIMENTS

In the following detailed description of the embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

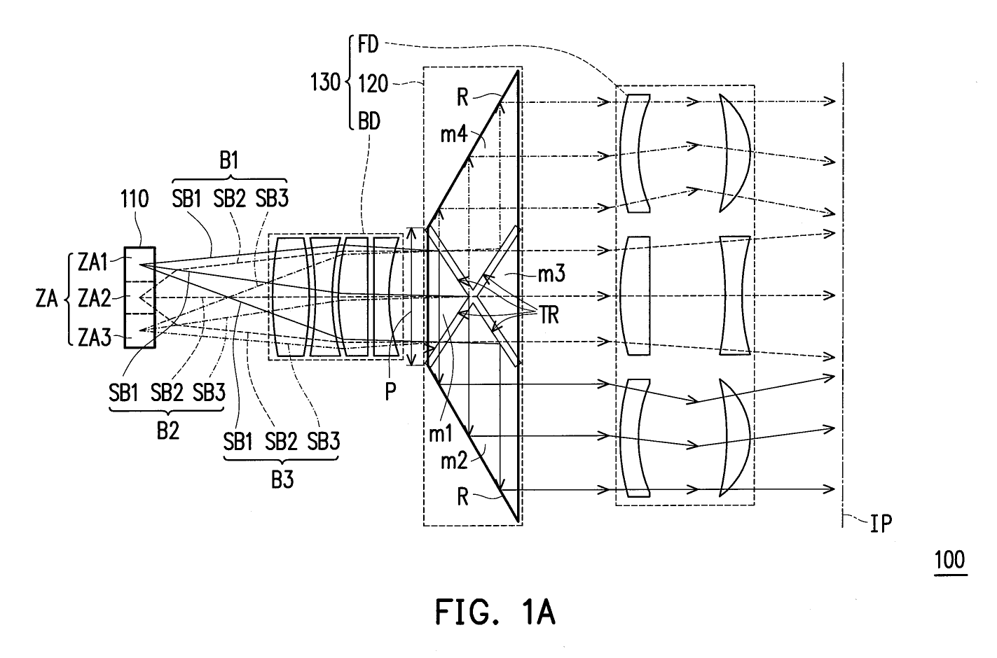

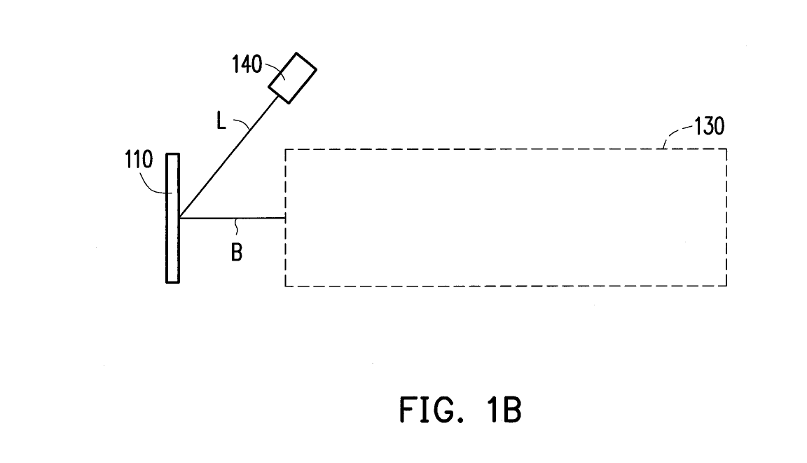

FIG. 1A is a schematic view illustrating a projection device according to an embodiment of the disclosure, whereas FIG. 1B is a variation of the projection device according to the embodiment illustrated in FIG. 1A. According to FIGS. 1A and 1B, in this embodiment, a projection device 100 includes an image source 110 a light-splitting module 120 and an imaging lens 130. The image source 110 provides an image beam B and includes a plurality of different image areas ZA. For example, the image source 110 may be a display panel, while the image areas ZA may be a plurality of display areas of the display panel. More specifically, in this embodiment, the projection device 100 may further include an illumination system 140 for providing an illumination beam L, as illustrated in FIG. 1B. In addition, the image source 110 may be a light valve, such as a liquid crystal panel or a digital micro-mirror device (DMD). The light valve may be configured on a transmission path of the illumination beam L, so as to convert the illumination beam L into the image beam B. For example, there are three image areas in this embodiment, which are image areas ZA1, ZA2, and ZA3 illustrated in FIG. 1A. However, the disclosure is not limited thereto. In this embodiment, the image beam B may include a plurality of sub-image beams SB respectively emitted from the image areas ZA. For example, the image area ZA1 may emit the sub-image beam SB1 (such as a light path illustrated with solid lines in FIG. 1A), the image area ZA2 may emit the sub-image beam SB2 (such as a light path illustrated with dotted lines in FIG. 1A), and the image area ZA3 may emit the sub-image beam SB3 (such as a light path illustrated with catenary lines in FIG. 1A). In addition, the imaging lens 130 includes the light-splitting module 120, a rear refractive-element group BD, and a front refractive-element group FD. As illustrated in FIG. 1, in this embodiment, the image beam B are, for example, divided into image beams B1, B2, and B3 emitted toward different positions of the light-splitting module 120. In addition, all the image beams B1 to B3 include a portion of the sub-image beam S1, a portion of the sub-image beam S2, and a portion of the sub-image beams S3. The light-splitting module 120 has at least one total reflection plane TR. In this embodiment, a number of the total reflection planes is two, for example. In addition, the total reflection planes intersect each other. However, the disclosure is not limited thereto. The total reflection planes TR enable to totally reflect at least one sub-image beam SB of the sub-image beams SB and allow at least another sub-image beam SB of the sub-image beams SB to transmit therethrough. Thereby, the sub-image beams SB from different image areas ZA are separated according to the corresponding image areas ZA.

More specifically, in this embodiment, each of the sub-image beams SB emitted to the corresponding total reflection planes TR with an incident angle greater than or equal to a critical angle of the corresponding total reflection plane TR may be reflected by the corresponding total reflection plane TR, while each of the sub-image beams SB emitted to the corresponding total reflection plane TR with an incident angle smaller than the critical angle of the corresponding total reflection plane may transmits through the corresponding total reflection plane TR. For example, in this embodiment, the total reflection planes TR totally reflect the sub-image beams SB1 and SB3 in the image beams B1 to B3 and allow the sub-image beams SB2 in the image beams B1 to B3 to transmit therethrough. As illustrated in FIG. 1A, the sub-image beams SB1 in the image beams B1 to B3 are totally reflected and split to one side of the light-splitting module 120 (the lower side of FIG. 1A), and the sub-image beams SB3 in the image beams B1 to B3 are also totally reflected and split to another side of the light-splitting module 120 (the upper side of FIG. 1A), and the sub-image beams SB3 are separated from the sub-image beam SB 1. In addition, the sub-image beams SB2 in the image beams B1 to B3 transmit through the total reflection planes TR and are split from the image beams SB1 and SB3.

More specifically, in this embodiment, the light-splitting module 120 may be formed by four prisms m1 to m4, and the total reflection planes TR are reflection planes formed by a gap among the prisms m1 to m4. In this embodiment, if a refraction index of a material of the prisms m1 to m4 is 1.43 and a refraction index of air is 1, it is derived from Snell's law that a critical angle θ of the total reflection planes TR is 44.371 degrees. In other words, if an incident angle of a beam is greater than the critical angle θ of the total reflection planes TR, the beam is totally reflected by the total reflection planes TR. However, in other embodiments, the gap among the prisms m1 to m4 may be filled with a material with a different refraction index or kept vacuum, or the total reflection planes may be formed by prisms made of different materials. The disclosure is not limited thereto. In this way, the light-splitting module 120 may split the sub-image beams SB generated from the different image areas ZA by making use of different incident angles to the light-splitting module 120. The split sub-image beams SB may have a light intensity similar to the light intensity of the image source 110 and carry image information of the corresponding image areas ZA. For example, the sub-image beams SB1 passing the light-splitter module 120 may have image information of the image area ZA1, the sub-image beams SB2 passing the light-splitter module 120 may have image information of the image area ZA2, and the sub-image beam SB3 passing the light-splitter module 120 may have image information of the image area ZA3. Thereby, the sub-image beams SB generated from the different image areas ZA may be split from each other without losing light intensity for subsequent processes (e.g. enlarging, splicing, changing to a different order, or a combination thereof). Meanwhile, a size of the light-splitting module 120 may be reduced and a manufacturing process of the light-splitting module 120 may be simplified by intersecting the total reflection planes TR. Thereby, the size of the projection device 100 as well as the cost may be further reduced. Specifically, numbers of the image beams, image areas, and sub-image beams, and light paths described above are only for illustrating this embodiment. In other embodiments, there may be a different number of the image beams, image areas, and sub-image beams, as well as variations of the light paths. The disclosure is not limited thereto.

In addition, in this embodiment, the imaging lens 130 may include a rear refractive-element group BD, and a front refractive-element group FD. The rear refractive-element group BD is configured on a transmission path of the image beam B and located between the image source 110 and the light-splitting module 120. The front refractive-element group FD is configured on transmission paths of the sub-image beams SB. Moreover, the front refractive-element group FD may include a plurality of lenses respectively configured on the transmission paths of the sub-image beams SB. An aperture P may be defined and located between the rear refractive-element group BD and the front refractive element group FD, and the light-splitting module 120 is configured between the rear refractive-element group BD and the front refractive-element group FD. For example, in this embodiment, the rear refractive-element group BD may collect the image beams B within a range of the aperture P and transmit the image beams B to the light-splitting module 120. In addition, the rear refractive-element group BD may also have a function of adjusting image and color aberrations. In this embodiment, the aperture P has a position at an intersection of the image beams from the image source 110 that are emitted from different fields but toward the same direction in the imaging lens 130. In other embodiments, an aperture stop may be configured at the aperture P to limit a luminous flux at the aperture P, wherein the aperture stop may be a light-shading element with an opening. However, there may not be an aperture stop configured for limiting the luminous flux at the aperture P in this embodiment. It should be noted that numbers and types of lens in the rear refractive-element group BD and the front refractive-element group FD illustrated in FIG. 1A are only for illustrating this embodiment. Other embodiments may include other types of lens or mirror having a refractive power. The disclosure is not limited thereto. In this embodiment, the light-splitting module 120 and the aperture P are both located between the rear refractive-element group BD and the front refractive-element group FD. In addition, in this embodiment, there is no element having a refractive power (e.g. a lens or a curved-surface mirror) configured between the aperture P and the rear refractive-element group BD, between the aperture P and the front refractive-element group FD, between the light-splitting module 120 and the rear refractive-element group BD, and between the light-splitting module 120 and the front refractive-element group FD. In other words, the light-splitting module 120 is configured on a light path between a refractive element in front of and closest to the aperture P and a refractive element behind and closest to the aperture P.

More specifically, the light-splitting module 120 may further have at least one reflection surface R. In this embodiment, a number of the reflection surfaces R is, for example, two. However, the disclosure is not limited thereto. The reflection surfaces R are configured on the transmission path of at least one sub-image beam SB of the sub-image beams SB from the total reflection planes TR, so as to reflect at least one sub-image beam SB to the front refractive-element group FD. For example, in this embodiment, the reflection surfaces R respectively reflect the sub-image beams SB 1 and SB3 toward the front refractive-element group FD. Therefore, the sub-image beams SB may be projected onto an imaging plane IP, wherein projections of the sub-image beams SB on the imaging plane IP are in an arrangement direction parallel to an arrangement direction of the image areas ZA1 to ZA3 of the image source 110. However, the disclosure is not limited thereto. In other embodiments, the projections from the imaging areas ZA1 to ZA3 may have variations such as parallel, oblique, or vertical arrangements in correspondence to configurations of the reflection surfaces R. In this embodiment, the imaging plane IP is, for example, formed of a screen or a display.

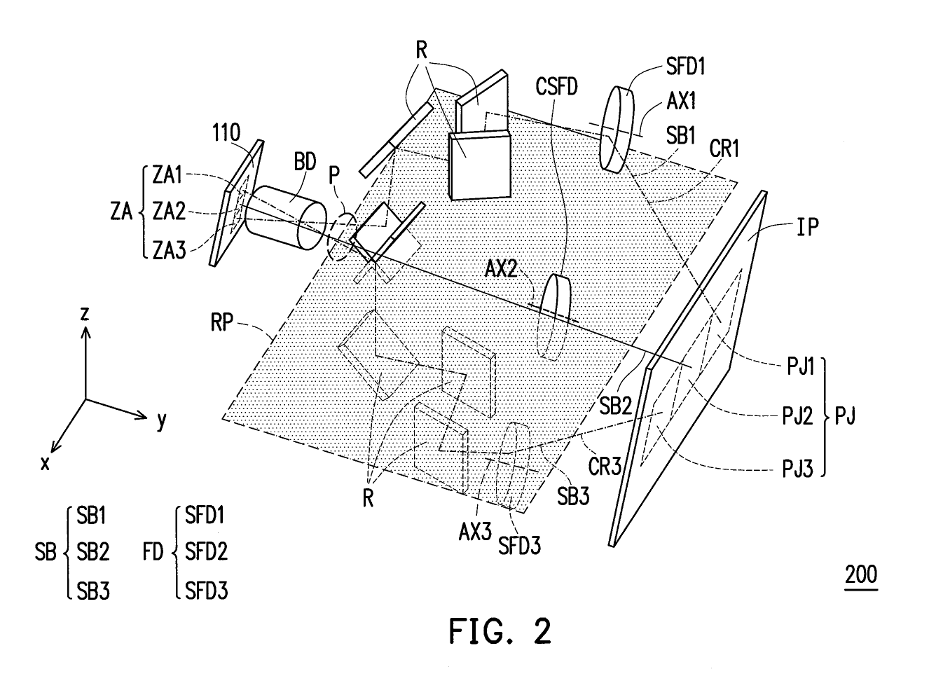

FIG. 2 is a schematic perspective view illustrating a projection device according to another embodiment of the disclosure. Referring to FIG. 2, the projection device 200 of FIG. 2 is similar to the embodiment of FIG. 1A, but differs in that projections of the sub-image beams SB on the imaging plane IP are in an arrangement direction vertical to the arrangement direction of the image areas ZA1 to ZA3 on the image source 110. More specifically, the front refractive-element group FD may include a plurality of sub-lens groups SFD (e.g. sub-lens groups SFD1, SFD3, and CSFD in FIG. 2) respectively configured on the transmission paths of the correspondnig sub-image beams SB. In addition, a central sub-lens group CSFD of the sub-lens group SFD is configured on the transmission path of a sub-image beam SB of the sub-image beams SB transmitting through the total reflection planes TR. The image areas ZA are arranged along a Z-direction (the Z-direction is the Z-axis in the three-dimensional coordinates illustrated in FIG. 2). When chief rays CR1 and CR3, which are emitted from central points of the corresponding image areas ZA, in any one of rest of the sub-image beams SB pass the corresponding sub-lens groups SFD, the chief rays CR1 and CR3 are located between a reference plane RP and the corresponding sub-lens groups SFD. The chief rays CR1 and CR3 here are defined as beams emitted from the central points of the corresponding imaging areas ZA and pass a central point of the aperture P.

The reference plane RP includes an optical axis AX2 of the central sub-lens group CSFD and is substantially vertical to the arrangement direction of the image areas ZA (i.e. the direction of Z-axis). Namely, the reference plane RP is parallel to a X-Y plane formed by X-axis and Y-axis. In other words, as illustrated in FIG. 2, when the chief ray CR1 passes the sub-lens group SFD1, the chief ray CR1 is located between an optical axis AX1 of the sub-lens group SFD1 and the reference plane RP. In addition, when the chief ray CR3 passes the sub-lens group SFD3, the chief ray CR3 is located between an optical axis AX3 of the sub-lens group SFD3 and the reference plane RP. It should be noted that in this embodiment, FIG. 2 only illustrates the chief ray CR1 of the sub-image beam SB1 and the chief ray CR3 of the sub-image beam SB3 to simplify and make FIG. 2 easy to read. However, the disclosure is not limited thereto. Thereby, the front refractive-element group FD may change transmitting directions of the sub-image beams SB1 and SB3, such that centers of projections PJ1, PJ2 and PJ3 of the sub-image beams SB1, SB2, and SB3 on the imaging plane IP fall on the reference plane RP. In addition, the projections PJ1, PJ2, and PJ3 of the sub-image beams SB1, SB2, and SB3 are in an arrangement direction vertical to the arrangement direction of the image areas ZA1 to ZA3. In other words, by adjusting configuration of the reflection surfaces R, an arrangement order of projections PJ of the image areas ZA on the imaging plane IP may be changed. Moreover, through modification of the sub-lens groups SFD, the projections PJ1 to PJ3, which are originally not on the same plane, may be arranged to be located on the same reference plane RP. Numbers of lenses, projections, and image areas disclosed above are only used to illustrate this embodiment. The disclosure is not limited thereto.

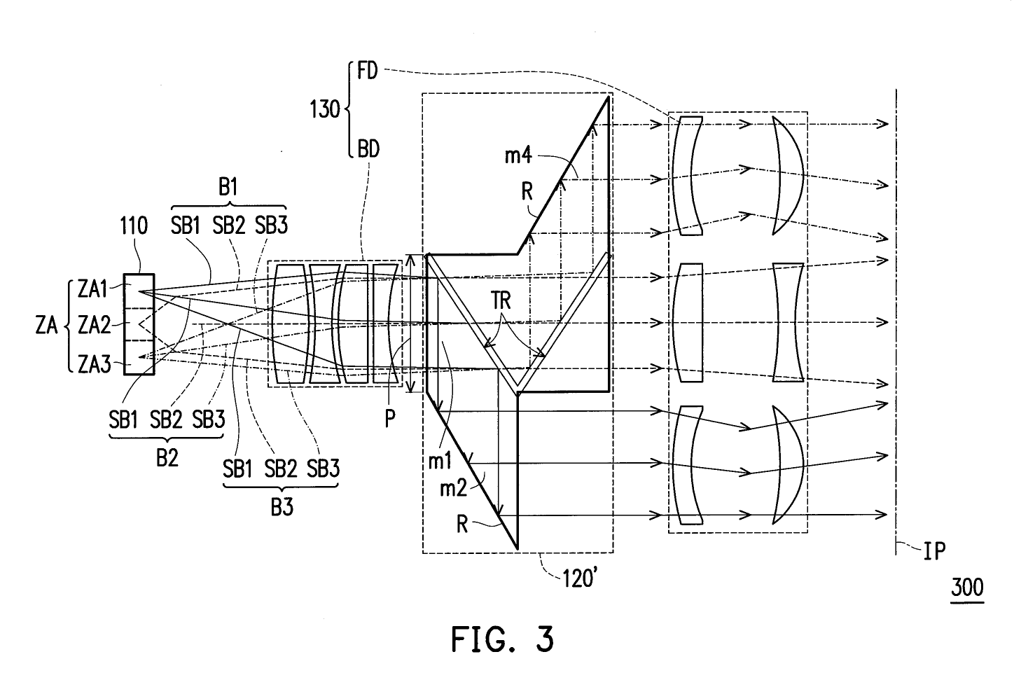

FIG. 3 is a schematic view illustrating a projection device according to another embodiment of the disclosure. Referring to FIG. 3, the projection device 300 illustrated in FIG. 3 is similar to the embodiment of FIG. 1A but differs in that the total reflection planes TR are sequentially arranged on a transmission path of at least one of the sub-image beams SB. In other words, the total reflection planes TR may be arranged in a V shape, as shown in FIG. 3, and may reflect the sub-image beams SB 1 and SB3. Thereby, an effect similar to that of FIG. 1A is achieved. In practical needs, when adjusting the total reflection planes TR (e.g. adjusting an angle or distance of the total reflection planes TR) of a light-splitting module 120′, adjusting the total reflection planes TR in an intersecting structure illustrated in FIG. 1A may simultaneously influence the transmitting directions of the sub-image beams SB1 and SB3, making it more difficult to separately adjust each of the total reflection planes TR. However, the total reflection planes TR in the light-splitting module 120′ do not intersect, making it possible to separately adjust each of the total reflection planes TR to achieve total reflections of the sub-image beams SB1 and SB3. Moreover, the difficulty of adjustment is reduced, so manufacture efficiency and quality are further improved.

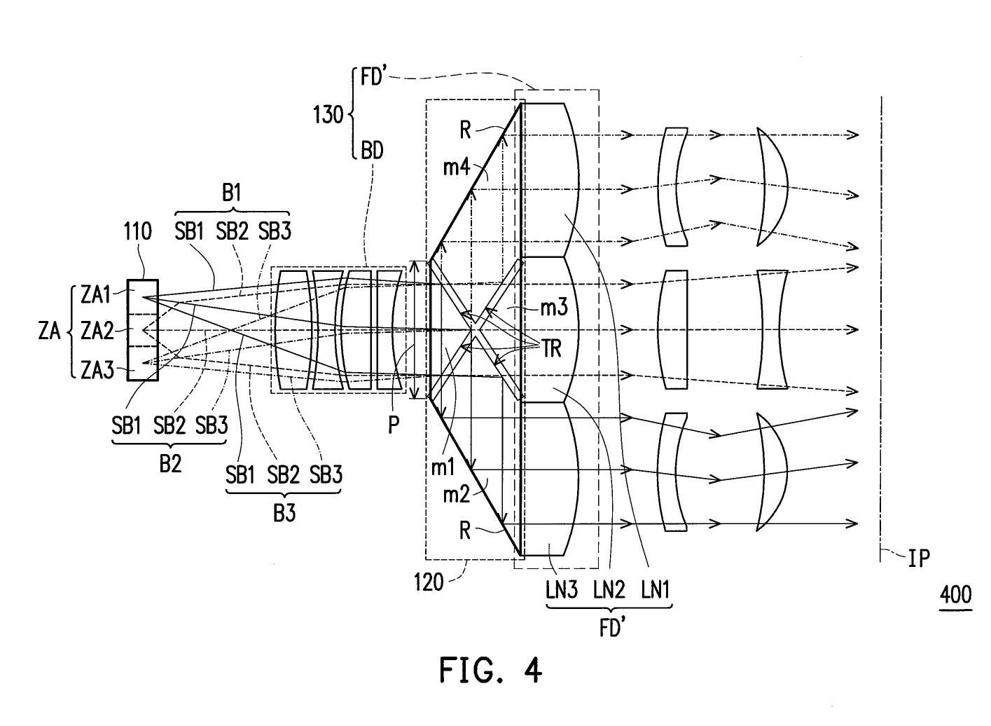

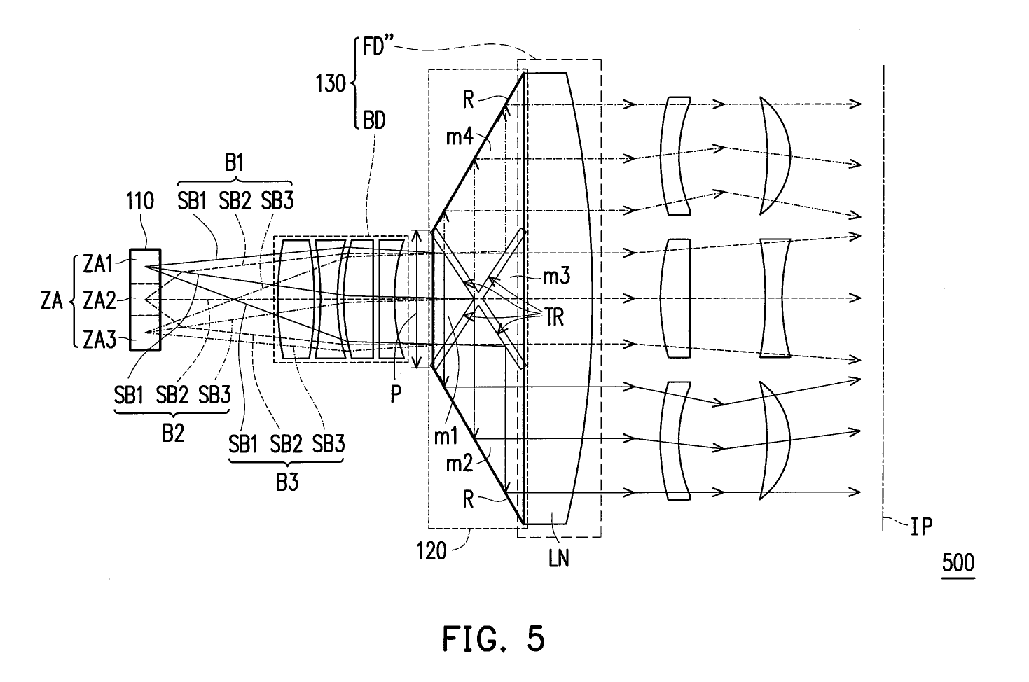

FIG. 4 is a schematic view illustrating a projection device according to still another embodiment of the disclosure, and FIG. 5 is a schematic view illustrating a projection device according to another embodiment of the disclosure. Referring to FIG. 4, the projection device 400 of FIG. 4 is similar to the projection device 100 in the embodiment illustrated in FIG. 1A but differs in that a front refractive-element group FD' of this embodiment includes a plurality of lenses (e.g. lenses LN1 to LN3 in FIG. 4), which may be laminated to or formed integrally with a portion or a complete portion of the prisms m1 to m4 of the light-splitting module 120. In this way, a structural strength of a projection device 400 may be further improved, thereby reducing movement of the front refractive-element group FD' caused by shakes or oscillations in operation and influencing projection quality. A number and shape of the lenses included in the front refractive-element group FD' is only used to illustrate this embodiment. The disclosure is not limited thereto. Alternatively, as illustrated in FIG. 5, the projection device 500 of FIG. 5 is similar to the projection device 400 in the embodiment illustrated in FIG. 4 but differs in a front refractive element group FD″ may also include a lens LN configured on the transmission paths of the sub-image beams SB, thereby achieving the effect of the front refractive-element group FD in the embodiments illustrated in FIG. 1A and the front refractive-element group FD' in FIG. 4 as well. In this embodiment, the lens LN may not contact with the prisms m1 to m4 of the light-splitting module 120. However, in other embodiments, the lens LN may also be laminated to or integrally formed with a portion or a complete portion of the prisms m1 to m4 of the light-splitting module 120. The disclosure is not limited thereto.

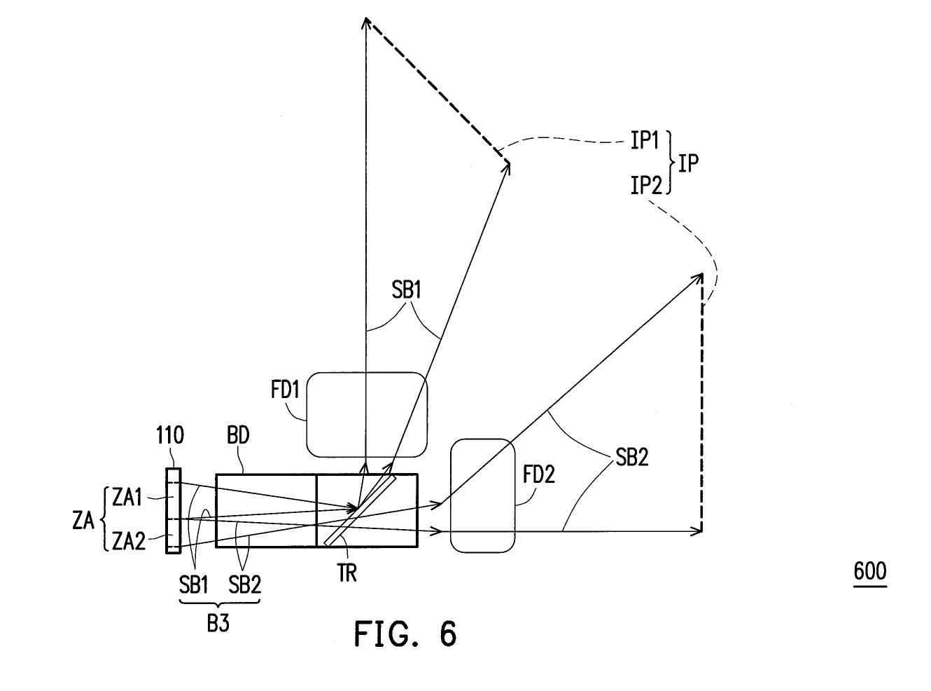

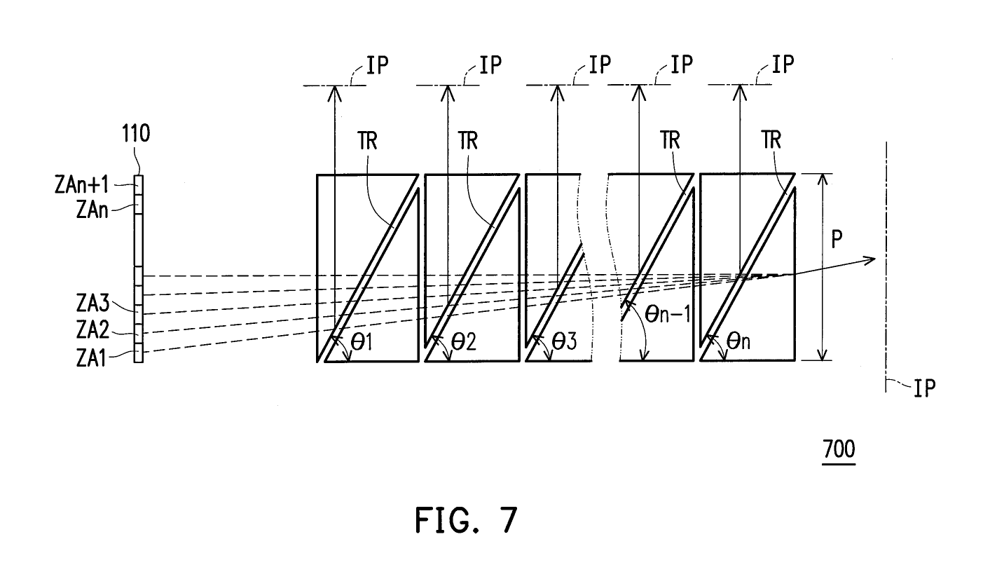

FIG. 6 is a schematic view illustrating a projection device according to another embodiment of the disclosure, and FIG. 7 is a schematic view illustrating a projection device according to another embodiment of the disclosure. Referring to FIG. 6, a projection device 600 of FIG. 6 is similar to the projection device 100 in FIG. 1A, but differs in that in this embodiment, the image areas ZA include, for example, two image areas ZA1 and ZA2, whereas the light-splitting module 120 includes one total reflection plane TR. The front refractive-element group FD makes the sub-image beams SB respectively project onto a plurality imaging planes IP, wherein at least a portion of the imaging planes IP are not on the same plane. For example, in this embodiment, the sub-image beams SB1 emitted from the image areas ZA1 are reflected by the total reflection plane TR, transmit toward a front refractive-element group FD1, and are projected onto an imaging plane IP1. In addition, the sub-image beams SB2 emitted from the image area ZA2 are reflected by the total reflection plane TR, transmit toward a front refractive-element group FD2, and are projected onto an imaging plane IP2. The imaging planes IP1 and IP2 are not on the same plane. In addition, projection distances from the image areas ZA1, ZA2 to the corresponding imaging planes IP 1 and IP2 are not identical. In this embodiment, the imaging planes IP1 and IP2 are not parallel to each other. However, in other embodiments, the imaging planes may be parallel to, partially parallel to, and completely not parallel to each other. More specifically, in this embodiment, projection ratios (i.e. a ratio between width of a projected image and projection distance) of the imaging planes IP1 and IP2 are different from each other. Thereby, the projection device 600 may project images of different image areas ZA onto different imaging planes IP, so as to have different projection distances and projection ratios to satisfy the needs of projection in different occasions. It should be noted that numbers of the total reflection plane TR, image areas ZA, as well as numbers, directions and projection ratios of the imaging planes IP are only used to illustrate this embodiment. In other embodiments, there may also be different numbers of the imaging planes IP, total reflection plane and image areas ZA, or there may be imaging planes IP that are partially parallel to each other or a part of the imaging planes having the same projection ratio.

For example, referring to FIG. 7, there is a projection device 700 that the image source 110 has n+1 image areas ZA and may correspondingly have n total reflection planes TR and n+1 imaging planes IP in this embodiment, n is positive number. As illustrated in FIG. 7, each of the n total reflection planes TR has a respective tilt angle from θ1 to θn, wherein sizes of the tilt angles θ1 to θn may be, for example, declining, such that the image beams from the n+1 image areas ZA1 to ZAn+1 are sequentially reflected by the total reflection planes TR, while the image beams that are not reflected transmit through the total reflection planes TR. Thereby, the projection device 700 may respectively project n+1 images on the corresponding imaging planes IP. In addition, the numbers of the front refractive-element group FD and the rear refractive-element group BD as well as relevant optical parameters may be adjusted based on practical needs to correspond to the imaging planes IP. Relevant adjustments are already described in the embodiments from FIG. 1A to FIG. 6, and will not be reiterated hereinafter. The imaging planes IP may have different or partially identical directions, projection distances, and projection ratios. The disclosure is not limited thereto.

In view of the foregoing, the embodiments of the disclosure have at least one of the following advantages or effects. The embodiments of the disclosure makes use of the light-splitting module having one or more total reflection planes to separate sub-image beams emitted from different image areas and having different incident angles. In addition, the projection directions may be changed by the front refractive-element group and the reflection surfaces, such that the projection device is allowed to project images parallel or vertical to the arrangement in the image areas. The separated sub-image beams may have a light intensity similar to the light intensity of the image source. In addition, the sub-image beams carry the image information of the corresponding image areas, thereby maintaining the light intensity of projection on the imaging plane. In addition, the light-splitting module totally reflects and separates different sub-image beams with different incident angles. In this way, the complexity of light-splitting mechanism may be reduced. Therefore, the projection device of the embodiments of the disclosure may project a plurality of images generated from only one light valve, which not only reduces the number of optical elements configured on the transmission paths of the image beams, but shrinks down the size of the projection device.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like does not necessarily limit the claim scope to a specific embodiment, and the reference to particular exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A projection device, comprising:
an image source, providing an image beam, wherein the image source comprises a plurality of different image areas, and the image beam comprises a plurality of sub-image beams respectively emitted from the image areas;
a light-splitting module, having at least one total reflection plane totally reflecting at least one sub-image beam of the sub-image beams and allowing at least another one sub-image beam of the sub-image beams to transmit therethrough;
a rear refractive-element group, configured on a transmission path of the image beam and located between the image source and the light-splitting module; and
a front refractive-element group, configured on transmission paths of the sub-image beams, wherein the rear refractive-element group and the front refractive-element group define an aperture, and the aperture is located between the rear refractive-element group and the front refractive-element group, and the light-splitting module is configured between the rear refractive-element group and the front refractive-element group.

2. The projection device as claimed in claim 1, wherein the at least one total reflection plane comprises a plurality of total reflection planes, and each of the sub-image beams emitted to the corresponding total reflection plane with an incident angle larger than or equal to a critical angle of the corresponding total reflection plane is totally reflected by the corresponding total reflection plane, wherein each of the sub-image beams emitted to the corresponding total reflection plane with an incident angle smaller than the critical angle transmits through the corresponding total reflection plane.

3. The projection device as claimed in claim 2, wherein at least a portion of the total reflection planes intersect each other.

4. The projection device as claimed in claim 2, wherein at least a portion of the total reflection planes are sequentially arranged on a transmission path of at least one sub-image beam of the sub-image beams.

5. The projection device as claimed in claim 2, wherein the front refractive-element group comprises a plurality of sub-lens groups respectively configured on the transmission paths of the sub-image beams, a central sub-lens group of the sub-lens groups is configured on a transmission path of the sub-image beams transmitting through the total reflection planes, the image areas are arranged in an arrangement direction, and a chief ray of one of the rest of the sub-image beams emitted from a central point of the corresponding image area is located between a reference plane and the corresponding sub-lens group when the chief ray passes the corresponding sub-lens group, wherein the reference plane comprises an optical axis of the central sub-lens group and substantially vertical to the arrangement direction.

6. The projection device as claimed in claim 1, wherein the light-splitting module further comprises at least one reflection surface configured on a transmission path of at least one sub-image beam of the sub-image beams from the total reflection planes, so as to reflect the at least one sub-image beam to the front refractive-element group.

7. The projection device as claimed in claim 1, wherein the front refractive-element group comprises a plurality of lenses respectively configured on the transmission paths of the sub-image beams.

8. The projection device as claimed in claim 7, wherein the light-splitting module comprises a plurality of prisms, wherein a gap is formed among the prisms to form the at least one total reflection plane.

9. The projection device as claimed in claim 8, wherein the lenses are laminated to or formed integrally with a portion or a complete portion of the prisms.

10. The projection device as claimed in claim 1, wherein the front refractive-element group further comprises a lens configured on the transmission paths of the sub-image beams, and the light-splitting module comprises a plurality of prisms, wherein a gap is formed among the prisms to form the at least one total reflection plane.

11. The projection device as claimed in claim 10, wherein the lens is laminated to or formed integrally with a portion or a complete portion of the prisms.

12. The projection device as claimed in claim 1, wherein the image areas are arranged along a first direction, a plurality of images formed by the sub-image beams being respectively and projected onto an imaging plane by the front-refractive element group are arranged along a second direction, and the first direction is substantially vertical to the second direction.

13. The projection device as claimed in claim 1, wherein the front refractive-element group enables the sub-image beams be projected onto a plurality of imaging planes, and at least a portion of the imaging planes are not on a same plane.

14. The projection device as claimed in claim 13, wherein at least a portion of the sub-image beams has a different projection distance.

15. The projection device as claimed in claim 13, wherein at least a portion of the imaging planes are not parallel to each other.

16. The projection device as claimed in claim 13, wherein at least a portion of the sub-image beams is projected with different projection ratios from the others.

17. The projection device as claimed in claim 1, wherein the image source is a display panel, and the image areas are a plurality of display areas of the display panel.

18. The projection device as claimed in claim 17, further comprising an illumination system providing an illumination beam, wherein the display panel is a light valve configured on a transmission path of the illumination beam, so as to convert the illumination beam into the image beam.

19. An imaging lens for imaging an image beam, the imaging lens comprises:
a light-splitting module, having at least one total reflection plane totally reflecting at least one sub-image beam of a plurality of sub-image beams in image beams and allowing at least another sub-image beam of the sub-image beams to transmit therethrough;
a rear refractive-element group, configured on a transmission path of the image beam; and
a front refractive-element group, configured on transmission paths of the sub-image beams, wherein the rear refractive-element group and the front refractive-element group define an aperture, the aperture is located between the rear refractive-element group and the front refractive-element group, and the light-splitting module is configured between the rear refractive-element group and the front refractive-element group.

20. The imaging lens as claimed in claim 19, wherein the at least one total reflection plane are a plurality of total reflection planes, and each of the sub-image beams emitted to the corresponding total reflection plane with an incident angle larger than or equal to a critical angle of the corresponding total reflection plane is totally reflected by the corresponding total reflection plane, wherein each of the sub-image beams emitted to the corresponding total reflection plane with an incident angle smaller than the critical angle transmits through the corresponding total reflection plane.

21. The imaging lens as claimed in claim 19, wherein the front refractive-element group comprises a plurality of lenses respectively configured on light-transmission paths of the sub-image beams, and the light-splitting module comprises a plurality of prisms, wherein a gap is formed among the prisms to form the at least one total reflection plane.
